(19) United States
(12) Patent Application Publication
(10) Pub. No.: US 2009/0000882 A1
(43) Pub. Date: Jan. 1, 2009

(54) Shrink Fitted Caliper Guidance Pins

(75) Inventor: Alf SIEBKE, Schondorf am Ammersee (DE)

Correspondence Address: CROWELL & MORING LLP;INTELLECTUAL PROPERTY GROUP, P.O. BOX 14300, WASHINGTON, DC, 20044-4300, US

(73) Assignee: BENDIX SPICER FOUNDATION BRAKE LLC, Elyria, OH (US)

(21) Appl. No.: 11/769,218

(22) Filed: Jun. 27, 2007

(51) Int. Cl. F16D 55/2265

(52) U.S. Cl. 188/73.45

(57) ABSTRACT

A guide pin for a sliding disc brake caliper and a carrier for the caliper are attached together by generating a difference in temperatures between a section of the guide pin and a section of the carrier. The section of the guide pin is then inserted into an aperture defined in the section of the carrier. Upon achieving or restoring thermal equilibrium between the guide pin and carrier sections, contact pressure between the section of the guide pin and a surface of the aperture is produced so as to secure the guide pin to the carrier and resist separation of the guide pin from the carrier.

### BACKGROUND OF THE INVENTION

1. Field of the Invention

This invention concerns an improved guide pin or guidance pin assembly by which a disc brake caliper can slide with respect to a carrier fixed to a non-rotatable vehicle part, as well as a process for producing the improved assembly.

2. Description of Related Art

U.S. Pat. No. 4,334,598 to Portolese discloses a disc brake assembly with pins supporting a caliper. Each pin has two different diameters, and a rib inside a bore captures the pin at its smallest diameter, thereby restricting movement.

U.S. Pat. No. 4,265,340 to Scott et al. relates to a caliper disc brake with sliding motion facilitated by a low-friction insert placed in the bore before a guide pin and retained by an interference fit in the bore. The guide pin is not permanently affixed at an opposite end of the bore.

U.S. Pat. No. 4,392,560 to Nakasu et al. discloses a caliper assembly with four guide pins. Certain pins are made less rigid, or a clearance between certain pins and corresponding bores is relatively large, so that one set of pins defines a main set of pins. Only one or two pins actually regulate a caliper shift direction as a result.

U.S. Pat. No. 4,446,947 to Le Deit is directed to a sliding caliper disc brake assembly in which a noise-reducing sleeve is inserted into a bore. A pin is screwed through the bore into a fixed carrier at a blind bore end.

U.S. Pat. No. 4,753,326 to Weiler et al. concerns a pin guide for a caliper disc brake in which an elastic damping and guiding thermoplastic member is provided. This member serves as a stop element, as its outer diameter is larger than the inner diameter of the bore.

U.S. Pat. No. 4,807,725 to Weiler et al. discloses a floating caliper disc brake with a guide bolt arrangement including a friction ring, a lug, a holding member, and an elastomeric piece. The elastomeric piece provides a set clearance between a brake pad and the brake disc.

U.S. Pat. No. 4,934,589 to Doble, while not particularly directed to a disc brake, discloses a method of attaching dissimilar metals or alloys through heat and pressure so that only one of the metals is deformed. Both pieces are heated, and interlocks between the materials are used to improve bonding.

U.S. Pat. No. 5,785,156 to Warwick et al. concerns a retaining pin arrangement for a disc brake in which the pin connection configuration allows pivoting of the caliper and a nut holds the retaining pin.

U.S. Pat. No. 5,874,388 to Hsu relates to a special lubricant composition for a disc brake caliper pin intended to eliminate metal-to-metal contact and exclude dirt, water, and other corrosive elements.

Finally, U.S. Pat. No. 6,397,983 to Roszman et al. discloses a sliding pin type disc brake assembly in which a guide pin and a mating bore are sized in such a way as to provide an interference fit resisting movement until pad wear is obtained. A resilient bushing that does not allow movement of a caliper rest position until pad wear is obtained can be added. A resilient bushing that precludes movement of the caliper rest position until the brake pad wear reaches a certain level can also be included.

Guide pins for sliding caliper disc brakes as disclosed in at least some of the patents mentioned above are usually attached to carriers by way of bolts having shanks with constant or variable diameters. During vehicle operation, the guide pins are loaded by lateral forces resulting from braking and inertial loading. Compensation for loading produced by the lateral forces must be made through high axial pre-stressing forces to prevent separation of guide pin faces from carrier surfaces. Due to requirements for compact construction and the attendant dimensional constraints, available guide pin face surface sizes and bolt diameter dimensions are quite limited. There is therefore a tendency to utilize high strength bolts with partially reduced shanks, which increases both cost and bolt sensitivity to critical factors such as corrosion and embrittlement.

When a bolt joint is repeatedly overloaded by lateral forces during vibration loading, contact of a guide pin face and a carrier can be lost locally. This results in increased bending moments on the bolt and resultant fatigue breakage, which usually occurs in the less stress-resistant threaded area of the bolt.

### SUMMARY OF THE INVENTION

One object of this invention is to provide a sliding caliper disc brake configuration having a more robust and cost efficient guide pin to carrier joint design that could be used to replace current designs having bolted guide pins. It is anticipated that a more robust and cost competitive design of this type could be in high demand in the air disc brake market.

It is another object of the invention to provide cost reduction through the need for a reduced number of components and the use of lower cost parts.

To provide a more robust guide pin to carrier joint design at the lowest possible cost, one proposal is to replace the currently bolted guide pins with guide pins attached to a carrier by a shrink-fit joint. A guide pin according to the invention thus features an oversize shaft portion or step, and is cooled in liquid nitrogen or by a similar process. The pin is then inserted into a bore defined in the carrier, which remains at ambient temperature, is cooled, or is slightly heated. Required “pre-tensioning” of the joint necessary to secure the fit between the pin and the carrier is automatically provided when the respective temperatures of the joined both parts meet.

For improved guide pin assembly, existing guide pins, including a bolt affixed by a nut, would be replaced by pins affixed to calipers by shrink fitted joints. Again, a guide pin affixed to a carrier in this way would have a defined oversize shaft portion or step, and would be cooled using liquid nitrogen or by another, similar process. The cooled pin would then be fitted in the ambient temperature, cooled, or slightly heated bore of the carrier. The necessary pre-tensioning of the joint to secure the fit is automatically provided when the temperatures of both parts meet. The overall robustness of the joint is improved because there is no bending motion on the bolt, and an installation torque of the pin can be more precisely monitored.

Advantages of the proposed invention include reduced manufacturing costs for components, since no bolts, no bores in the guide pins, and no threads in the carrier are needed. Reduced assembly costs also result, since there is no yield strength torque application to the bolt as is currently used. Improved robustness and strength are provided to the joint, resulting in parts having lower sensitivity and in elimination of bending moment on the bolt in cases of overload. According to one embodiment of the invention, moreover, it is additionally possible to provide for replacement of the guide pin with a standard pin and bolt connection should it be necessary to service the caliper sliding system.

Benefits of the invention, as alluded to above, also include reduced pin machining, elimination of the need for screws, reduced assembly time, and improved pin bending resistance.

According to particular features of the invention, the guide pin and the carrier are attached by generating a difference in temperatures between a section of the guide pin and a section of the carrier, inserting the section of the guide pin into an aperture defined in the section of the carrier, and creating thermal equilibrium between the guide pin and carrier sections. As the guide pin and carrier sections approach thermal equilibrium, contact pressure between the section of the guide pin and a surface of the aperture is produced so as to attach the guide pin to the carrier and resist guide pin and carrier separation.

The difference in temperatures can be generated by contacting the section of the guide pin with liquid nitrogen, for example by immersing that section into a liquid nitrogen bath.

In one preferred configuration, the guide pin includes a first portion having a first diameter and a second portion having a second diameter smaller than the first diameter, with the second portion of the guide pin defining the section of the guide pin inserted into the aperture. Insertion of the guide pin section can be terminated upon abutment between the carrier and a stop or shoulder on the pin, or prior to such abutment, in which case a gap would remain between the stop or shoulder and the carrier. The second portion could have sufficient length that it extends completely through the aperture and beyond an end of the aperture, and could have external threads defined thereon to facilitate subsequent removal from the aperture.

### BRIEF DESCRIPTION OF THE DRAWINGS

FIG. 1 is an illustration, partly in section, of a portion of a conventional guidance system permitting sliding movement between a caliper and a carrier secured to a non-rotating vehicle part.

FIG. 2 shows a first embodiment of a guidance system according to the invention including a guide pin assembled to a carrier by shrink fitting rather than by way of a threaded connection.

FIG. 3 shows a second embodiment of the guidance system but in which the guide pin has an elongated small diameter portion defining a shaft extension.

FIG. 4 is a view of a system similar to that of FIG. 3 but in which a space is provided between a boundary on the guide pin and an area of the carrier to facilitate disassembly and service.

FIG. 5 shows another embodiment of the guidance system in which the guide pin has a threaded portion permitting easy disassembly from the carrier and field replacement with a standard screw joint.

FIG. 6 is an end view of the guide pin shown in FIG. 5.

### DETAILED DESCRIPTION OF THE DRAWINGS

The disc brake assembly disclosed by U.S. Pat. No. 4,334,598 to Portolese, generally discussed above, includes pins received in threaded apertures defined in arms of a carrier, torque plate, or support fixture. The pins extend from a side of the carrier to support a caliper in a known manner. The entire disclosure of the Portolese patent is incorporated herein by reference as non-essential subject matter. It will be recognized from the following description that the present invention is intended to provide a simplified interconnection appropriate for use in place of threaded connections such as those existing between the pins and the carrier, torque plate, or support fixture of the Portolese disc brake assembly.

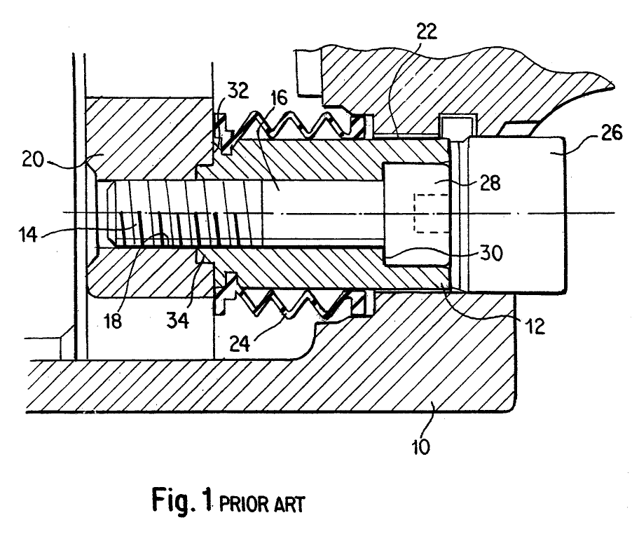

One environment in which the present invention is advantageously useful is that of an air disc brake having a caliper, guide pin, and carrier configuration such as that shown in FIG. 1. FIG. 1 illustrates a caliper 10 slidably received, in a known manner, on a guide pin 12. The guide pin 12 shown in FIG. 1 is one of a pair of guide pins typically providing for relative displacement between the caliper 10 and a carrier 20 secured to a non-rotating part of the vehicle. A threaded shank 14 of a caliper bolt 16 is received in a correspondingly threaded bore 18 provided in a carrier 20. Illustrations and discussions of configurations such as that shown in FIG. 1 are provided, for example, by Bendix Spicer Foundation Brake LLC Service Data publication SD-23-7541, the disclosure of which is also incorporated herein by reference as non-essential material.

The assembly shown in FIG. 1 further includes a guide sleeve 22 interposed between relatively movable surfaces of the caliper 10 and the guide pin 12, a contaminant inhibiting inner boot 24 surrounding the cylindrical outer surface of the guide pin 12, and a cover 26 adapted to overlie an opening providing access to the head 28 of the caliper bolt 16. Application of torque to the caliper bolt head 28 screws the shank 14 into the bore 18 so that the guide pin 12 is secured to the carrier 20 by a compressive force existing between the head 28, which acts on a first end or section 30 of the guide pin 12, and an inboard side or surface 32 of the carrier 20, which acts on a second end or section 34 of the guide pin.

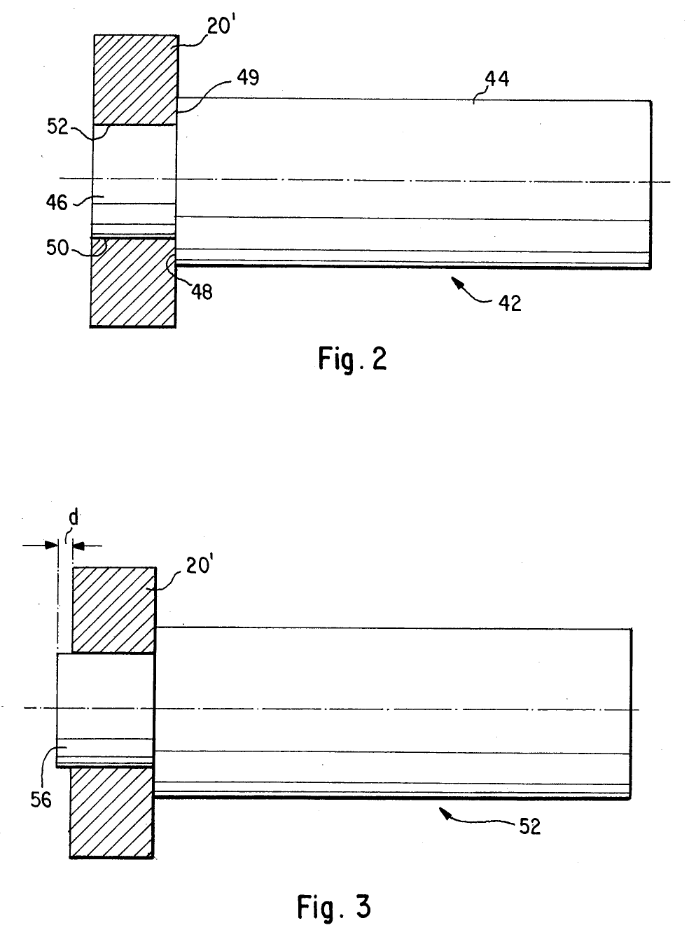

FIGS. 2-5 illustrate components of guidance systems according to the present invention. The guide pin in each of the systems shown in FIGS. 2-5 is affixed to a caliper by a shrink fitted joint with necessary pre-tensioning. Each of the guidance systems of FIGS. 2-5 is intended to replace a guidance system such as that defined by the guide pin 12, the caliper bolt 16, and the carrier 20 in the configuration of FIG. 1.

The first arrangement illustrated in FIG. 2 includes a guide pin 42 having a first, large diameter portion 44, a second, small diameter portion 46, and at least one boundary 48 separating the first and second portions 44 and 46 from each other. In the arrangement shown in FIG. 2, the boundary 48 is defined by a flat, substantially radially extending shoulder, but it is to be understood that the boundary could have a conical, stepped, curved, or other configuration, if desired. The second portion 46 of the pin 42 has an outer circumferential surface 50 that, as illustrated, is surrounded by a corresponding inner circumferential surface 52 of a bore or other opening defined in the carrier 20′.

To join the guide pin 42 to the carrier 20′, at least a portion of the guide pin 42, including the second portion 46, is cooled to an appropriate temperature. The entire pin 42, of course, could be cooled. Cooling could be effected in any suitable way, such as, for example, by immersing the pin or a portion thereof in liquid nitrogen, which has a maximum temperature of approximately −195.8° C. at one atmosphere. This cooling would result in volumetric contraction of the pin 42 or any portion of the pin 42 subjected to that cooling, thereby permitting the second portion 46 of the pin to be fitted into the bore defined in the carrier 20′, which remains at ambient temperature or which may be cooled or even heated, if desired. Insertion of the second portion 46 of the pin into the carrier bore continues until the boundary 48 engages a facing inboard area 49 of the carrier, at which point insertion is terminated.

After insertion terminates, thermal equilibrium is eventually achieved or restored. A shrink fit process, with possible interlocks between the body of the pin and the carrier, thus occurs as the pin is heated, thereby achieving “pre-tensioning” of the joint. Contact pressure between the surfaces 50 and 52, once thermal equilibrium is achieved or restored, automatically provides a high friction coefficient. This high friction coefficient serves to retain the second portion 46 of the guide pin 42 within the bore defined in the carrier 20′ by opposing any force tending to remove the second guide pin portion 46 from that bore. The overall robustness of the joint is improved, since the conventional caliper bolt 16, typically subjected to bending motion, is eliminated.

The second arrangement shown in FIG. 3 includes a guide pin 52 configured and assembled together with a carrier 20′ in ways nearly the same as the guide pin and carrier of the first arrangement. In the second arrangement, however, the second, small diameter portion 56 is dimensioned to extend by a dimension “d” beyond an outboard end of the bore defined in the carrier 20′ that receives the second pin portion.

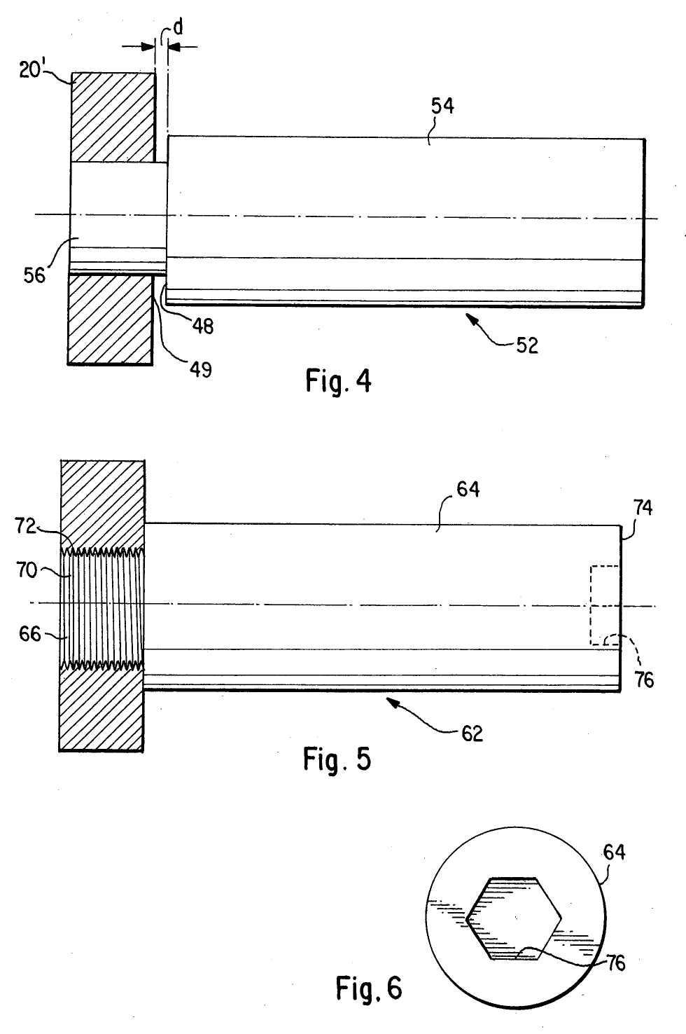

The third arrangement shown in FIG. 4 includes a guide pin 52 configured and assembled together with a carrier 20′ in essentially the same ways as in the second arrangement shown in FIG. 3. In the third arrangement, however, the boundary or surface 48 located between the guide pin portions 54 and 56 is displaced from the inboard area 49 of the carrier by the dimension “d.” In the third arrangement, therefore, a gap remains between the carrier 20′ and the guide pin boundary 48 to facilitate brake disassembly and service.

In the fourth arrangement shown in FIGS. 5 and 6, the guide pin 62 includes a first, large diameter portion 64, again separated by a radial surface or other boundary from a second, small diameter portion 66. In this arrangement, the second guide pin portion 66 includes external threads 70 formed thereon. The external threads 70 cooperate with corresponding internal threads 72 defined in the carrier bore to permit easy disassembly and field replacement, possibly with a conventional arrangement utilizing a guide pin 12 and a caliper bolt 16 as illustrated in FIG. 1. The inboard end 74 of the guide pin 62 is preferably provided with a tool receptacle, such as the hexagonal recess 76 shown, permitting rotation of the pin 62 by an appropriate tool when desired. The installation torque of the guide pin can be precisely monitored by way of the assembly procedure described.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A process for attaching a guide pin for a sliding disc brake caliper to a carrier comprising:
generating a difference in temperatures between a section of the guide pin and a section of the carrier;
inserting said section of the guide pin into an aperture defined in the section of the carrier; and
creating thermal equilibrium between the guide pin and carrier sections to produce contact pressure between the section of the guide pin and a surface of the aperture, attach the guide pin to the carrier, and resist separation of the guide pin from the carrier.

2. The process of claim 1, wherein the difference in temperatures is generated by contacting the section of the guide pin with liquid nitrogen.

3. The process of claim 1, wherein the guide pin includes a first portion having a first diameter and a second portion having a second diameter smaller than the first diameter.

4. The process of claim 3, wherein the second portion of the guide pin defines the section of the guide pin inserted into the aperture.

5. The process of claim 3, further comprising terminating insertion of the section of the guide pin into the aperture by abutment between a boundary delimiting the first and second portions of the guide pin.

6. The process of claim 3, further comprising terminating insertion of the section of the guide pin into the aperture prior to abutment between a boundary delimiting the first and second portions of the guide pin to avoid contact between the boundary and the carrier.

7. The process of claim 5, wherein the second portion extends completely through the aperture and beyond an end of the aperture.

8. The process of claim 3, wherein the second portion of the guide pin defines external threads.

9. The process of claim 1, further comprising removing the guide pin from the aperture.

10. The process of claim 5, wherein the boundary is defined by a shoulder interconnecting the first and second portions of the guide pin.

11. A guide pin for a sliding disc brake caliper in combination with a carrier to which the guide pin is attached by the process of claim 1.

12. A disc brake assembly comprising:
a carrier securable to a vehicle part;
a guide pin including a section thereof affixed to the carrier; and
a caliper slidable along the guide pin with respect to the carrier;
wherein the guide pin is affixed to the carrier by volumetric expansion of said section of the guide pin within an aperture in the carrier as the carrier and the section of the guide pin reach thermal equilibrium.

13. The disc brake assembly according to claim 12, wherein the guide pin includes a first portion having a first diameter and a second portion having a second diameter smaller than the first diameter.

14. The disc brake assembly according to claim 13, wherein the second portion of the guide portion defines the section of the guide pin within the aperture.

15. The disc brake assembly according to claim 13, further comprising a boundary delimiting the first and second guide pin portions.

16. The disc brake assembly according to claim 15, wherein the boundary abuts a surface of the carrier.

17. The disc brake assembly according to claim 15, wherein the boundary is displaced from an adjacent surface of the carrier to define a gap.

18. The disc brake assembly according to claim 15, wherein the second portion extends completely through the aperture and beyond an end of the aperture.

19. The disc brake assembly according to claim 13, wherein the second portion of the guide pin defines external threads.

20. The disc brake assembly according to claim 15, wherein the boundary is a substantially radially extending shoulder.
